(19) United States
(12) Patent Application Publication
(10) Pub. No.: US 2011/0028216 A1
(43) Pub. Date: Feb. 3, 2011

(54) METHOD AND SYSTEM FOR A MUSIC-BASED TIMING COMPETITION, LEARNING OR ENTERTAINMENT EXPERIENCE

(75) Inventors: Amnon SARIG, Woodland Hills, CA (US); Ran Cohen, Tel Aviv (IL)

Correspondence Address: NAOMI ASSIA C/O;LANDON IP, INC, 1725 JAMIESON AVENUE, ALEXANDRIA, VA, 22314, US

(73) Assignee: TuneWiki Inc, Milpitas, CA (US)

(21) Appl. No.: 12/639,025

(22) Filed: Dec. 16, 2009

Related U.S. Application Data
(63) Continuation-in-part of application No. PCT/IL2009/000756, filed on Aug. 3, 2009.

(51) Int. Cl. A63F 13/00; A63F 9/24

(52) U.S. Cl. 463/35; 463/37

(57) ABSTRACT

A method for a timing exercise performed on one of a dedicated player handset with screen and appropriate programming and a PC having appropriate programming and a screen, wherein a song is played, and wherein at least one sensor is provided to monitor activities of at least one participant. The method includes showing representations of the musical elements of the song on the screen of the dedicated player and recognizing at least one of the movements, facial expressions, body language, speech and identity of at least one participant; and as a result causing the representations to be “activated” by the participant, in the right order, at the right time and over the right duration.

### CROSS REFERENCE

This application is a continuation-in-part of PCT Application No. PCT/IL2009/000756, dated Aug. 3, 2009, entitled “A METHOD AND A SYSTEM FOR LYRICS COMPETITION, EDUCATIONAL PURPOSES, ADVERTISING AND ADVERTISING VERIFICATION,” which application is incorporated by reference herein in its entirety, and hereinafter referred to as the “LyricsLegend” application.

### FIELD OF THE INVENTION

The present invention relates generally to a game format, and more particularly to a method and a system for a game, learning or entertainment experience involving a series of onscreen objects related to the timing of a song, and one participant, or multiple participants in turn, need to burst the objects, in the right order, at the right time.

### BACKGROUND OF THE INVENTION

In US Pat. Applic. No. 20080026792, Mobile Terminal and Method of Capturing Image Thereof, Joo Hee Son teaches a method by which a user can accurately capture a specific image in the course of viewing images. An embodiment of the present invention includes if a specific timing point is selected while images are displayed, displaying images for a prescribed time corresponding to the specific timing point per a prescribed number of frames; and if at least one of the images displayed per the prescribed number of frames is selected, capturing the selected at least one image.

In US Pat. Applic. No. 20090038468, Interactive Music Training and Entertainment System and Multimedia Role Playing Game Platform, Brennan discloses embodiments of a music training and entertainment system that allow a user to input a selection of source music in a native format, and isolate a desired vocal or instrument component within the source music. The user selects the component of the source music against which he or she will be compared. The system suppresses the non-selected components of the source content to isolate the user-selected component.

The system receives user input corresponding to the isolated component, such as a vocal track, and matches the receiver's performance to the original performance. The system then provides meaningful and entertaining feedback to allow the user to practice and improve his or her performance. In a multi-user configuration a number of users, such as a band or ensemble can provide a performance, or individual users can compete against each other to see who can obtain the highest score.

In a graphical user interface, avatars representing parties within the system are displayed in relation to an audience. Audience reaction is configured to reflect a score obtained by the user. A lyric extraction and generation process displays lyrics to a song in virtual real time to the user as the music track is played to the user.

In US Pat. Applic. No 20060199156, Kugo describes a Typing Game Apparatus, wherein, if the portion of the lyrics of a song which is being reproduced is not the first verse and when the evaluation related to typing is in an unfavorable state, screen division is performed, and the display state of the image of a Promotional Video which is being displayed on a second liquid crystal display is made one step worse. On the other hand, if the portion of the lyrics of a song which is being reproduced is the first verse, then the image of the PV of this song is clearly displayed in a full screen on the second liquid crystal display.

Prior art FIG. 1 is a screen-shot illustrating the “full body motion capture” feature of the Natal add-on peripheral sensor 120, which is superimposed in a typical position on the screen shot. Two participants are shown, the nearer of which 110, is shown with skeletal markers 111, which are only visible to the sensor, thereby enabling the “full body motion capture” feature. In this case participant 110 is shown “kicking” a virtual football, which they see on the screen of a video monitor positioned off-screen, behind sensor 120, Participant 110 is thus her/himself the controller.

The Project Natal sensor is an approximately 9-inch (23 cm) wide horizontal bar connected to a small circular base with a ball joint pivot, and is designed to be positioned lengthwise above or below the video display. The device features an “RGB camera, depth sensor, multi-array microphone, and custom processor running proprietary software,” which provides full-body 3D motion capture, facial recognition, and voice recognition capabilities.

Thus, it would be advantageous to provide an method and system for a music-based timing competition, learning or entertainment experience involving a series of onscreen objects related to the timing of a song being played, and one participant, or multiple participants in turn, need to activate the objects, in the right order, at the right time.

### SUMMARY OF THE INVENTION

Accordingly, it is a principal object of the present invention to provide a game involving a series of onscreen objects related to the timing of a song, and one participant, or multiple participants in turn, need to burst the objects, in the right order, at the right time.

It is a further principal object of the present invention to provide hints for the next beat, such as in the case of guitar images for a game or learning rhythms or guitar fingerings, where the correct chord to hold your fingers on is shown as a hint.

It is a one further principal object of the present invention to provide a game enabling a participant to improve his/her timing relative to chosen songs.

It is a still one further principal object of the present invention to provide a sensor such as fighter pilot shooting goggles that allows “no-hands touching” of instruments in the right grasp, sequence and duration.

It is a still another principal object of the present invention to provide a sensor in the form of gloves that allows participants to play musical instruments in the right grasp, sequence and duration, and all hand activity is recognized and reacted to by the inventive system.

It is one other principal object of the present invention to provide a feature where, if the participant misplaces his fingers, the system sounds a buzzer or other unpleasant noise.

It is yet one other principal object of the present invention to provide a feature where, if the participant proceeds correctly, the system evokes a harmonious sound and/or awards points.

It is another principal object of the present invention to provide a feature where a drum set is used to set difficulty levels by adding more pieces in the drum set, for example more drum sizes, more percussion instruments to drum on, such as claves or cowbell in order to make it more difficult. In the case of a guitar more chords in the available chord-set on the virtual guitar can increase the difficulty ‘level’ of a guitar game or lesson.

A method is disclosed for a timing exercise performed on one of a dedicated player handset with screen and appropriate programming and a PC having appropriate programming and a screen, wherein a song is played, and wherein at least one sensor is provided to monitor activities of at least one participant. The method includes showing representations of the musical elements of the song on the screen of the dedicated player and recognizing at least one of the movements, facial expressions, body language, speech and identity of at least one participant; and as a result causing the representations to be “activated” by the participant, in the right order, at the right time and over the right duration.

There has thus been outlined, rather broadly, the more important features of the invention in order that the detailed description thereof that follows hereinafter may be better understood. Additional details and advantages of the invention will be set forth in the detailed description, and in part will be appreciated from the description, or may be learned by practice of the invention.

### BRIEF DESCRIPTION OF THE DRAWINGS

For a better understanding of the invention with regard to the embodiments thereof, reference is now made to the accompanying drawings, in which like numerals designate corresponding elements or sections throughout, and in which:

Prior art FIG. 1 is a screen-shot illustrating the “full body motion capture” feature of the Natal add-on peripheral sensor, which is superimposed in a typical position on the screen shot;

FIG. 2a is an exemplary schematic illustration of the opening screen showing a single hand drum, constructed in accordance with the principles of a preferred embodiment of the present invention;

FIG. 2b is an exemplary schematic illustration of the opening screen showing a drum set, constructed in accordance with the principles of a preferred embodiment of the present invention;

FIG. 3 is an exemplary schematic illustration of a game or learning screen showing randomly ordered lyrics associated with each guitar chord for the corresponding word in the lyrics, constructed in accordance with the principles of a preferred embodiment of the present invention;

FIG. 4 is an exemplary schematic illustration of an expanded drum set with other percussion instruments, constructed in accordance with the principles of a preferred embodiment of the present invention; and

FIG. 5 is an exemplary flow chart of the method for lyrics competition and learning experience, providing hand movement recognition, performed in accordance with the principles of a preferred embodiment of the present invention.

### DETAILED DESCRIPTION OF AN EXEMPLARY EMBODIMENT

The principles and operation of a method and an apparatus according to the present invention may be better understood with reference to the drawings and the accompanying description, it being understood that these drawings are given for illustrative purposes only and are not meant to be limiting.

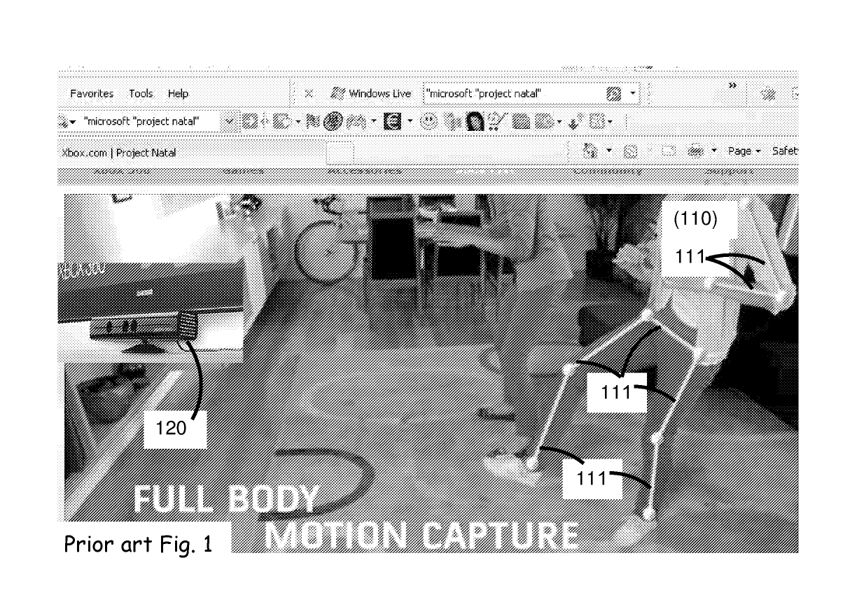

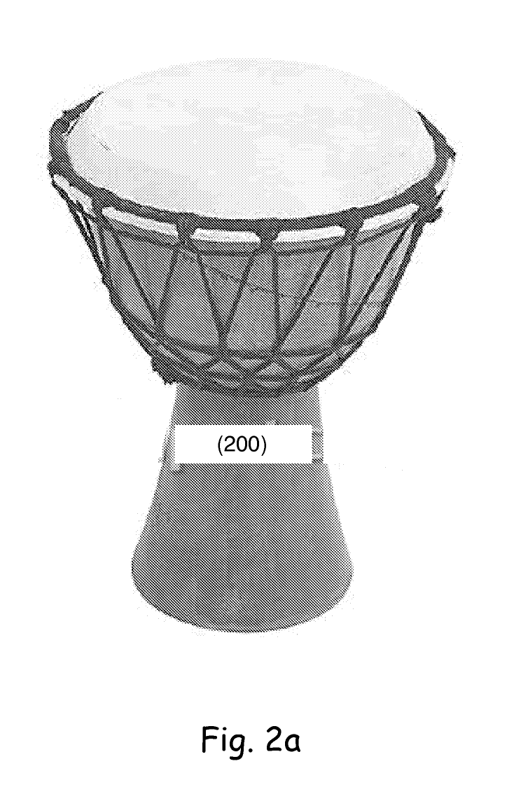

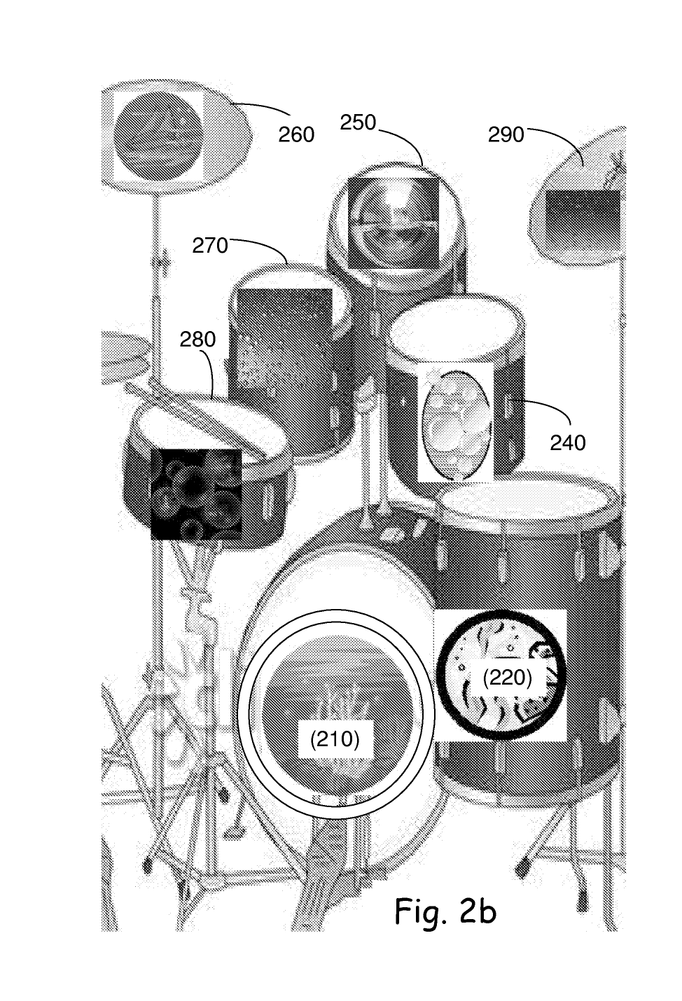

FIG. 2a is an exemplary schematic illustration of the opening screen showing a single hand drum, constructed in accordance with the principles of a preferred embodiment of the present invention. Single hand drum 200 is to be struck, either by hand or with a stick or mallet, in the proper timing for the song being played.

FIG. 2b is an exemplary schematic illustration of the opening screen showing a drum set, constructed in accordance with the principles of a preferred embodiment of the present invention. The drums, 210, 220, 230, 240, 250, 260 and 270 and cymbals 280 and 290 are to be struck in the correct timing and sequence, corresponding to the chosen song being played. One or more drums or cymbals can have multiple beats relative to others. The level of difficulty is preferably pre-selected. Hints for the next drum(s) and/or cymbal(s) to be struck are provided for example, wherein the next beat is indicated by a tight black circle 210. The beat after that is indicated by a loose white circle 220.

More difficult modes may be without hints. More difficult requirements can include more complex rhythms, such as syncopation, “off-beat rhythms,” and differing amounts of force for the different drums and other percussions.

Claves, for example, can normally be struck perpendicularly for a loud, sharp sound to emphasize the beat. They can also be struck in parallel for a doubled sound as one pair of ends strikes before the other, and with a variety of pitches. A participant can be sitting at an actual drumset or holding an actual guitar, and a device, such as the MicroSoft Natal Project™ device can determine the timing and correctness of chord fingerings and other movements.

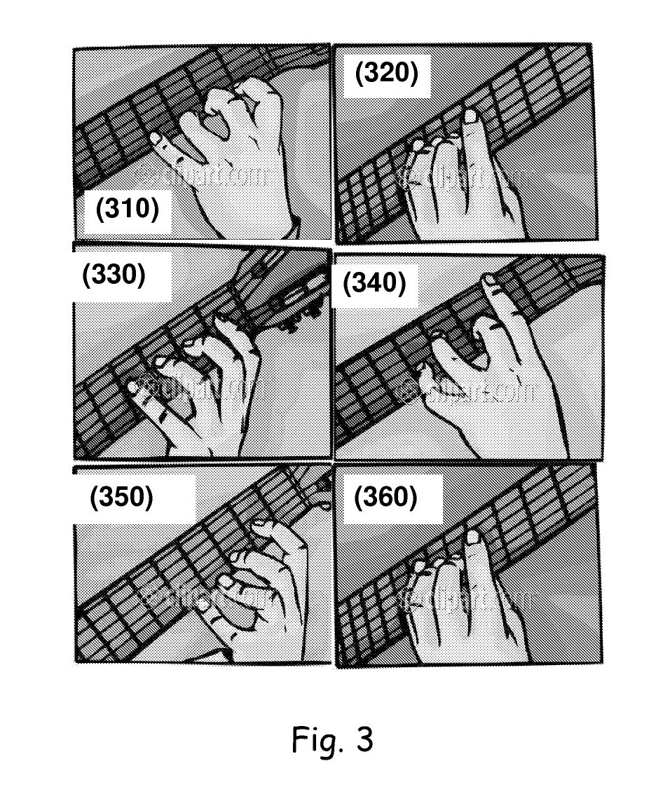

FIG. 3 is an exemplary schematic illustration of a game or learning grouping showing randomly ordered lyrics associated with each guitar chord 310, 320, 330, 340, 350 or 360 for a sequence of chords, constructed in accordance with the principles of a preferred embodiment of the present invention. In a simple beginners mode the guitar can simply be “strummed” for each chord in the correct timing. Advanced mode can be implemented for “right-hand” picking.

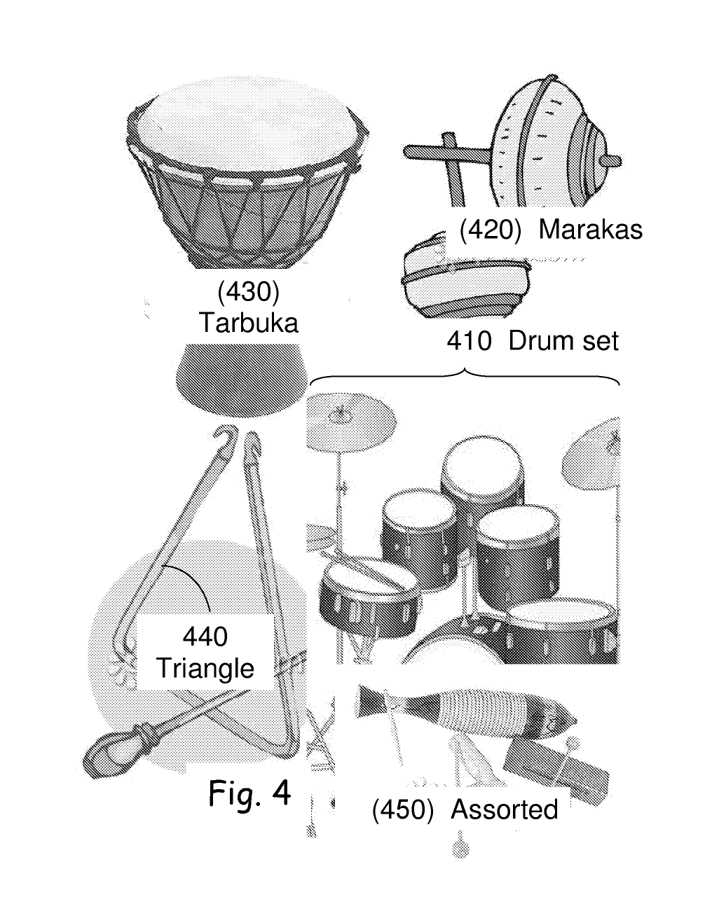

FIG. 4 is an exemplary schematic illustration of a game or learning or entertainment grouping showing an expanded set of percussion instruments for a higher level game or learning or entertainment situation, constructed in accordance with the principles of a preferred embodiment of the present invention. The original drumset 410 of FIG. 2 is shown along with maracas 420, a tarbuka 430, a triangle 440 and a grouping of assorted other percussion instruments 450.

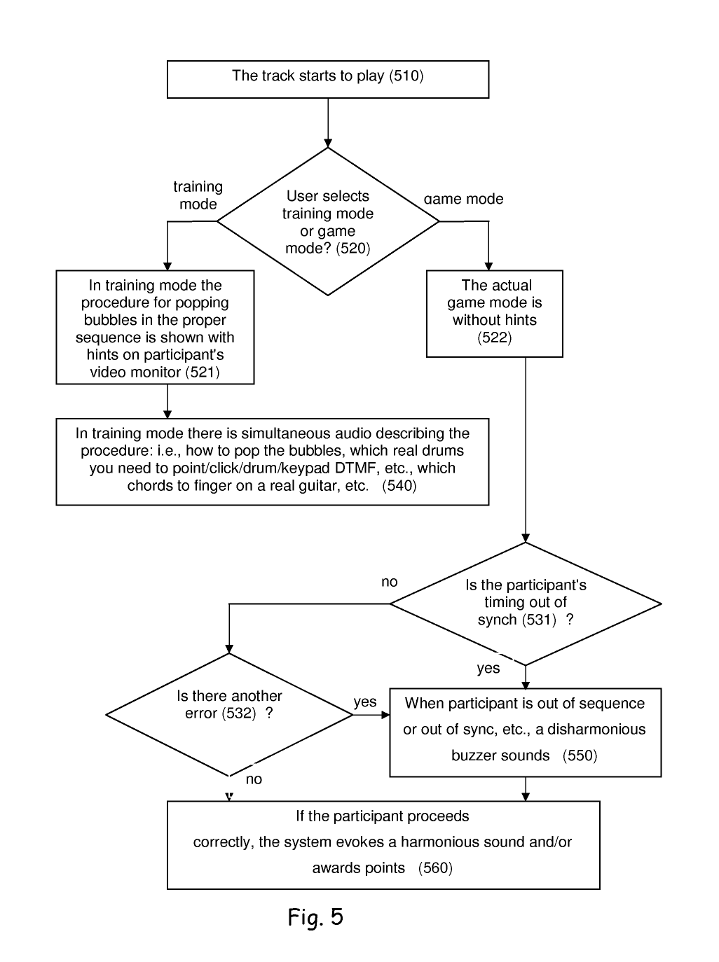

FIG. 5 is an exemplary flow chart of a game or learning situation, constructed in accordance with the principles of a preferred embodiment of the present invention. The sequence of operation is as follows. The song track sequence starts to play 510. If the participant selects training mode 520, then the procedure for identifying the timing sequence is shown 521 with hints on the participant's video monitor, with simultaneous audio describing the procedure: i.e., how to pop the bubbles, which real drums you need to point/click/drum/keypad DTMF, etc., which chords to finger on a real guitar, etc 540. The competition/learning mode is without hints 522. When the participant is out of sequence 531 or out of sync 532, a disharmonious buzzer sounds 550. If the participant proceeds correctly, the system evokes a harmonious sound and/or awards points 560.

In this game, you probably need to use multiple fingers and to be good, have very good coordination both hands.

Having described the present invention with regard to certain specific embodiments thereof, it is to be understood that the description is not meant as a limitation, since further modifications will now suggest themselves to those skilled in the art, and it is intended to cover such modifications as fall within the scope of the appended claims.

We claim:

1. A method for a timing exercise performed on one of a dedicated player handset with a screen and appropriate programming and a PC having appropriate programming and a screen, wherein a song is played, and wherein at least one sensor is provided to monitor activities of at least one participant, said method comprising:
showing representations of the musical elements of the song on the screen of the dedicated player;
recognizing at least one of the movements, facial expressions, body language, speech and identity of said at least one participant; and as a result
causing said representations to be “activated” by the participant, in the right order, at the right time and over the right duration.

2. The method of claim 1 wherein said exercise is a competitive game.

3. The method of claim 1 wherein said exercise is an entertainment experience.

4. The method of claim 1 wherein said exercise is an educational experience.

5. The method of claim 1, wherein said representations are in the form of keys of an electronic keyboard and a note or chord of the song is played for an extended period of time, and wherein said at least one participant needs to activate the correct key or keys to correspond to the start of playing the note at the right time and continue said activation until the note or notes are done being played.

6. A system for a timing exercise performed on one of a dedicated player handset with screen and appropriate programming and a PC having appropriate programming and a screen, wherein a song is played, and wherein at least one sensor is provided to monitor activities of at least one participant, said system comprising:
means for showing representations of the musical elements of the song on the screen of the dedicated player;
means for recognizing at least one of the movements, facial expressions, body language, speech and identity of said at least one participant; and as a result
means for causing said objects to “activated” by the participant, in the right order, at the right time and over the right duration.
